(19) United States
(12) Patent Application Publication
(10) Pub. No.: US 2005/0143077 A1
(43) Pub. Date: Jun. 30, 2005

(54) System and method for designing a communications network

(76) Inventor: Hugo Charbonneau, Montreal (CA)

Correspondence Address: Hugo CHARBONNEAU;c/o PROTECTIONS EQUINOX INT'L INC., Suite 224, 4480, Cote-de-Liesse, Montreal, QC, H4N 2R1, CA

(21) Appl. No.: 10/744,018

(22) Filed: Dec. 24, 2003

(51) Int. Cl. H04Q 7/20

(52) U.S. Cl. 455/446

(57) ABSTRACT

A computer-implemented method is disclosed for creating a Distributed Antenna Network for use in designing a wireless communications network. The method includes interconnecting on a design screen canvas at least one selected component, from a components database stored in a computer system, with at least one defined signal source system. The signal source system has a source of signal and a plurality of specified system parameters. A method of designing wireless network, a computer readable medium, a computer system and a method of generating an equipment list report for use in a building-based network are also disclosed.

### FIELD OF THE INVENTION

The present invention concerns wireless communications networks, and more particularly to a system and method for designing a wireless communications network.

### BACKGROUND OF THE INVENTION

Mobile communications devices, such as cellular telephones, pagers and the like, are now commonplace and are now being used more indoor than in vehicles. With the new form factor of cellular phones and the growing demand for wireless data services, the mobile traffic has shifted from outdoors to indoors, where typically Radio Frequency (RF) penetration is often limited. To maximize ARPU (Average Revenues Per Users), reduce the percentage number of deactivations (CHURN), and maintain customer satisfaction, wireless operators have to optimize their network and do RF deployment inside buildings using state-of-the-art technologies to improve coverage, data throughput and capacity. In-building RF design is very complex, especially nowadays with the advent of multi-carriers and multi-technologies that are requested by the building's owners. These systems can cause serious deterioration of the network if they are not engineered correctly. Moreover, wireless operators may suffer from a lack of knowledge and expertise and may not take full advantage of their in-building networks.

Several types of software and systems have been developed to address the problems of in-building network designs, a few examples of which are illustrated as follows:
U.S. Pat. No. 6,625,454, issued Sep. 23, 2003, to Rappaport et al. for ‘Method and System for Designing or Deploying a Communications Network which Considers Frequency Dependent Effects’;
U.S. Pat. No. 6,336,035, issued Jan. 1, 2002, to Somoza et al. for ‘Tools for Wireless Network Planning’;
U.S. Pat. No. 6,356,758, issued Mar. 12, 2002, to Almeida et al. for ‘Wireless Tools for Data Manipulation and Visualization’;
U.S. Pat. No. 6,317,599, issued Nov. 13, 2001, to Rappaport et al. for ‘Method and System for Automated Optimization of Antenna in 3-D’;
U.S. Pat. No. 6,199,032, issued Mar. 6, 2001, to Anderson for ‘Presenting an Output Signal Generated by a Receiving Device in a Simulated Communication System’; and
U.S. Pat. No. 6,119,009, issued Sep. 12, 2000, to Baranger et al. for ‘Method and Apparatus for Modeling the Propagation of Wireless Signals in Buildings’.

The aforesaid methods and systems, however, perform only the prediction part of a network design. Currently other separate software tools such as Word™, Excel™, Visio™ and AutoCAD™ are often required to perform subsequent design operations. These methods tend to be error prone, complicated and not standard from one designer to another.

With the aforesaid methods, often the steps include the use of a) prediction software or data collection in the field followed by b) antenna network design using Excel™, Word™, Visio™, and the like. When the designer chooses to use prediction software in step a), errors are often included since it is based on theoretical modeling. In this case, often the designer will choose to do the data collection in the field as well to correlate his results. However, step b) still has the problem of combining multiple separate tools which brings standardization problems and design errors.

In addition, many of the systems are complex and require multiple measurements to be taken and verified by engineers located in the wireless network. Often the measurements are not based on actual facts about the environment, but are based on theoretical models, which would compromise the accuracy of the final design. None of the aforesaid designs appear to be integrated into a single software package that is accessible from a personal computer.

Thus there is a need for an improved software and system for designing wireless communications networks.

### SUMMARY OF THE INVENTION

The present invention reduces the difficulties and disadvantages of the prior art by providing software and a system, which enables the wireless designers to use one common tool to design, adjust, evaluate costs, prepare installation plans and print all the documentation necessary for an in-building wireless communications network. Advantageously, the software supports multiple sources of signal such as multi-carriers and multi-technologies on multiple systems on the same design. The software automatically calculates downlink and uplink losses/gains (link budget) at each connector on a design screen canvas, which significantly reduces design errors and enables system components' incompatibilities to be detected and corrected. The design screen canvas advantageously displays representations of system components and connectors and enables the designer to connect the components on screen using a user-friendly drag-and-drop technique. Another aspect of user-friendliness is found in the on-screen accessibility of a components database. On-screen windows enable the designer to scroll through a list of components in the database and to select the desired components therefrom. The selected components can also be located on a two-dimensional floor plan to generate the network installation plans. The detailed graphics of each system component is a novel feature, which advantageously enhances the visual impact of the documentation while increasing the ease of understanding how the system/plurality of systems is composed. In another advantageous aspect of the invention, the designer can generate reports with the components overlaid onto installation plans and produce equipment lists and cost reports containing information based on unit cost and installation cost of each component.

According to a first embodiment of the present invention, there is provided a computer-implemented method for creating a Distributed Antenna Network for use in designing a wireless communications network, the method comprising:
interconnecting on a design screen canvas at least one selected component, from a components database stored in a computer system, with at least one defined signal source system having a source of signal and a plurality of specified system parameters.

Preferably, multiple signal source systems are interconnected with multiple components.

Typically, the components database is accessible from the design screen canvas, the component being selected based on the specified system parameters.

Preferably, the component is selected from a list of available components based on specific properties of each of the available components.

Typically, the signal source system includes a signal source, a technology, a band of frequencies and a block of frequencies.

Preferably, the selected component is placed and represented on the design screen canvas.

Preferably, the method described above further includes:
selecting a cabling component from the components database;
representing the selected cabling component on the design screen canvas; and
interconnecting the selected components using the selected cabling component.

Preferably, the selected components are interconnected on the screen design canvas using an on-screen pointing device implemented drag-and-drop technique.

Preferably, the method described above further includes:
validating the compatibility of the interconnected components with the signal source system; and
calculating a link budget at each of the compatible interconnected components.

Preferably, a debug window is displayed on the design screen canvas, the debug window displaying debug window messages when the interconnected components are incompatible with a compatibility check selected from the group consisting of: signal source systems, impedance verification, voltage compatibility, active component saturation, voltage drop, maximum power handling and connector type. Preferably, the compatibility check is signal source systems, active component saturation and connector types.

Preferably, the method described above further includes:
transposing the interconnected components onto at least one installation plan of the wireless communications network.

Preferably, a first report is generated having thereon a graphical representation of the Distributed Antenna Network.

Preferably, a second report is generated having thereon a graphical representation of the at least one installation plan.

Preferably, an equipment list is generated, the list including information on each of the components.

Preferably, a cost report is generated having thereon costing information based on cost data for each of the components.

Preferably, the wireless communications network is located within a building. The interconnected components are transposed onto at least one floor plan of the building.

Preferably, the design screen canvas is a graphical representation of the wireless communications network.

Typically, the design screen canvas is located on a computer display unit.

Typically, the Distributed Antenna Network is a 2-Dimensional representation of the wireless communications network.

In an alternative aspect of the first embodiment of the present invention, the wireless communication network is located exterior of the building.

According to a second embodiment of the present invention, there is provided a computer-implemented method for designing a wireless communications network, the method comprising:
creating a Distributed Antenna Network, as described in the first embodiment; and
transposing the Distributed Antenna Network onto at least one installation plan of the wireless communications network.

According to a third embodiment of the present invention, there is provided a computer-readable data storage medium having a data storage material encoded with the computer implemented method steps, as described in the first embodiment.

According to a fourth embodiment of the present invention, there is provided a computer-readable data storage medium having a data storage material encoded with the computer implemented method steps, as described for the second embodiment.

According to a fifth embodiment of the present invention, there is provided a computer system for generating a 2-Dimensional representation of a Distributed Antenna Network, the system comprising:
a computer-readable storage medium including a data storage material encoded with the computer implemented method steps, as described for the first embodiment;
a memory for storing instructions for processing the data;
a central processing unit coupled to the computer-readable storage medium for processing the computer readable data into the representation; and
a display unit coupled to the central processing unit for displaying the representation.

According to a sixth embodiment of the present invention, there is provided a computer system for generating a representation of a wireless communications network, the method comprising:
a computer-readable storage medium including a data storage material encoded with the computer implemented method steps, as described in the second embodiment;
a memory for storing instructions for processing the data;
a central processing unit coupled to the computer-readable storage medium for processing the computer readable data into the representation; and
a display unit coupled to the central processing unit for displaying the representation.

According to a seventh embodiment of the present invention, there is provided a computer-readable medium having stored thereon a design of a Distributed Antenna Network, created as described in the first embodiment.

According to an eighth embodiment of the present invention, there is provided a computer-readable medium having stored thereon a design of a wireless communication network, created as described in the second embodiment.

According to a ninth embodiment of the present invention, there is provided an in-building wireless communications network designed, as described in the second embodiment.

According to a tenth embodiment of the present invention, there is provided a software tool suite for designing an in-building wireless communications network, the suite comprising:
a display, on a design screen canvas, of at least one defined signal source system having a source of signal and a plurality of specified system parameters;
a display of at least one selected component selected from a components database stored in a computer system and accessible from the design screen canvas, the component being selected based on the specified system parameters; and
a graphical representation of a Distributed Antenna Network created by
interconnecting the selected component on the design screen canvas.

According to an eleventh embodiment of the present invention, there is provided a method of generating a report having thereon a graphical representation of a Distributed Antenna Network, the method comprising:
creating data from the Distributed Antenna Network created as described in the first embodiment;
storing instructions for processing the data;
processing the data in a central processing unit coupled to a computer-readable storage medium into the graphical representation and generating the graphical representation; and
displaying the graphical representation on a display unit coupled to the central processing unit.

According to a twelfth embodiment of the present invention, there is provided a computer system for generating a report having thereon a graphical representation of a Distributed Antenna Network, the system comprising:
a computer-readable storage medium including a data storage material encoded with the computer implemented method steps, as described in the first embodiment;
a memory for storing instructions for processing the data;
a central processing unit coupled to the computer-readable storage medium for processing the computer readable data into the graphical representation and for generating the graphical representation; and
a display unit coupled to the central processing unit for displaying the graphical representation.

According to a thirteenth embodiment of the present invention, there is provided a method of generating a report having thereon a graphical representation of at least one installation plan, the method comprising:
creating data from the Distributed Antenna Network created as described in the first embodiment;
storing instructions for processing the data;
processing the data in a central processing unit coupled to a computer-readable storage medium into a graphical representation of the Distributed Antenna Network and generating the graphical representation of the Distributed Antenna Network;
displaying the graphical representation of the installation plan on a display unit coupled to the central processing unit.

According to a fourteenth embodiment of the present invention, there is provided a computer system for generating a report having thereon a graphical representation of at least one installation plan, the system comprising:
a computer-readable storage medium including a data storage material encoded with the computer implemented method steps, as described in the first embodiment;
a memory for storing instructions for processing the data;
a central processing unit coupled to the computer-readable storage medium for processing the computer readable data into the graphical representation and for generating the graphical representation; and
a display unit coupled to the central processing unit for displaying the graphical representation.

According to a fifteenth embodiment of the present invention, there is provided a method of generating an equipment list for a wireless communications network, the method comprising:
creating data from the Distributed Antenna Network created as described in the first embodiment;
storing instructions for processing the data;
processing the data in a central processing unit coupled to a computer-readable storage medium into the equipment list and generating a graphical representation of the equipment list; and
displaying the graphical representation of the equipment list on a display unit coupled to the central processing unit.

According to a sixteenth embodiment of the present invention, there is provided a computer system for generating an equipment list for a wireless communications network, the system comprising:
a computer-readable storage medium including a data storage material encoded with the computer implemented method steps, as described in the second embodiment;
a memory for storing instructions for processing the data;
a central processing unit coupled to the computer-readable storage medium for processing the computer readable data into the representation and for generating the equipment list; and
a display unit coupled to the central processing unit for displaying the equipment list.

According to a seventeenth embodiment of the present invention, there is provided a method of generating a cost report for a wireless communications network, the method comprising:
creating data from the Distributed Antenna Network created as described in the first embodiment;
storing instructions for processing the data;
processing the data in a central processing unit coupled to a computer-readable storage medium into the cost report and generating a graphical representation of the cost report; and
displaying the graphical representation of the cost report on a display unit coupled to the central processing unit.

According to an eighteenth embodiment of the present invention, there is provided a computer system for generating a cost report for a wireless communications network, the system comprising:
a computer-readable storage medium including a data storage material encoded with the computer implemented method steps, as described in the second embodiment;
a memory for storing instructions for processing the data;
a central processing unit coupled to the computer-readable storage medium for processing the computer readable data into the representation and for generating the cost report containing cost information based on cost data associated with the system components; and
a display unit coupled to the central processing unit for displaying the cost report.

### BRIEF DESCRIPTION OF THE DRAWINGS

Further aspects and advantages of the present invention will become better understood with reference to the description in association with the following Figures, in which:

FIG. 1 is a printout of a designed Distributed Antenna Network (DAN);

FIG. 1a is a representation of a floor plan with a transposed thereon;

FIG. 2 is a computer screenshot of a software suite showing a designed DAN;

FIG. 3 is a block diagram of an embodiment of the software of the present invention;

FIG. 4 is a flow diagram showing a general method of the present invention;

FIG. 5 is a flow diagram showing the steps of a method for defining a project;

FIG. 6 is a flow diagram showing the steps of a method for creating a signal source system;

FIG. 7 is a computer screenshot of a signal source system parameters;

FIG. 7a is a computer screenshot of information about a specific type of source;

FIG. 8 is a flow diagram showing the steps of a method for selecting DAN components from a database before interconnecting the components;

FIG. 9 is a computer screenshot of a database parts editor;

FIG. 9a is a computer screenshot of a modified component in the database;

FIG. 10 is a computer screenshot of components selection from the database;

FIG. 11 is a flow diagram of the steps of selecting a cabling component, connecting the components and verifying the component's compatibility;

FIG. 12 is a computer screenshot of a generated equipment list report; and

FIG. 13 is a computer screenshot of a generated cost report.

### DETAILED DESCRIPTION OF THE PREFERRED EMBODIMENTS

Abbreviations used herein include:
CDMA: Code-Division Multiple Access;
AMPS: Advanced Mobile Phone Service;
GPRS: General Packet Radio Services;
UMTS: Universal Mobile Telecommunications Service;
SMR: Specialized Mobile Radio;
PCS: Personal Communications Services;
DCS: Digital Collection System;
iDEN: Integrated Digital Enhanced Network; and
ISM: Industrial Scientific Medical.
   I: Methods of Designing a Wireless Communications Network

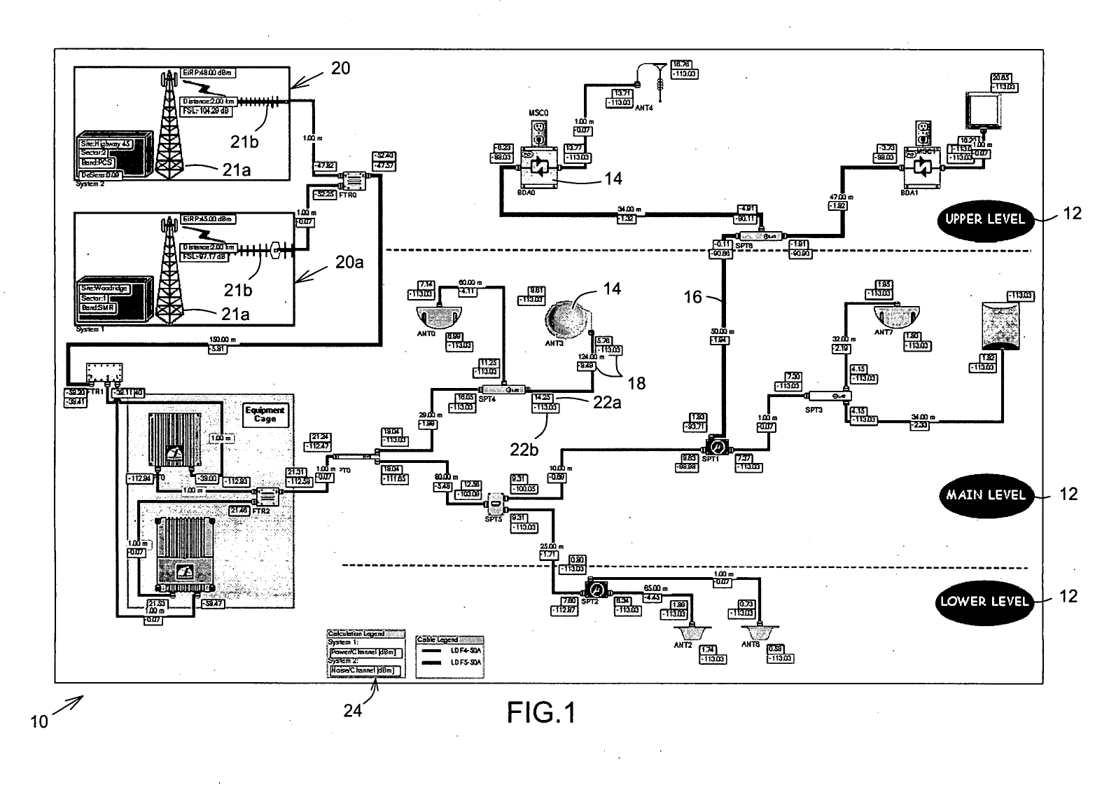

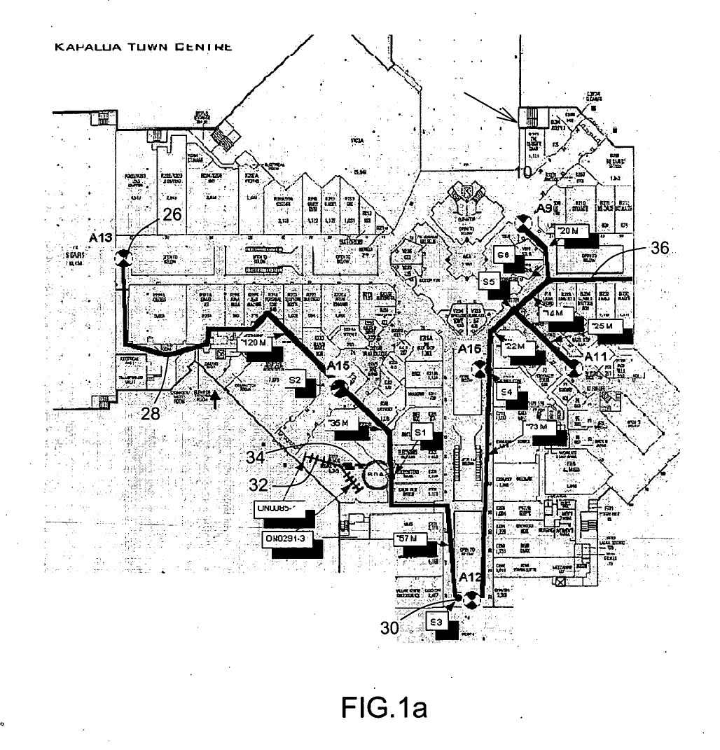

According to a first embodiment of the present invention, there is provided a computer-implemented method for creating a Distributed Antenna Network (DAN), as illustrated in FIG. 1, for use in designing an in-building wireless communications network, the method comprising:
interconnecting on a design screen canvas at least one selected component, from a components database stored in a computer system, with at least one defined signal source system having a source of signal and a plurality of specified system parameters.

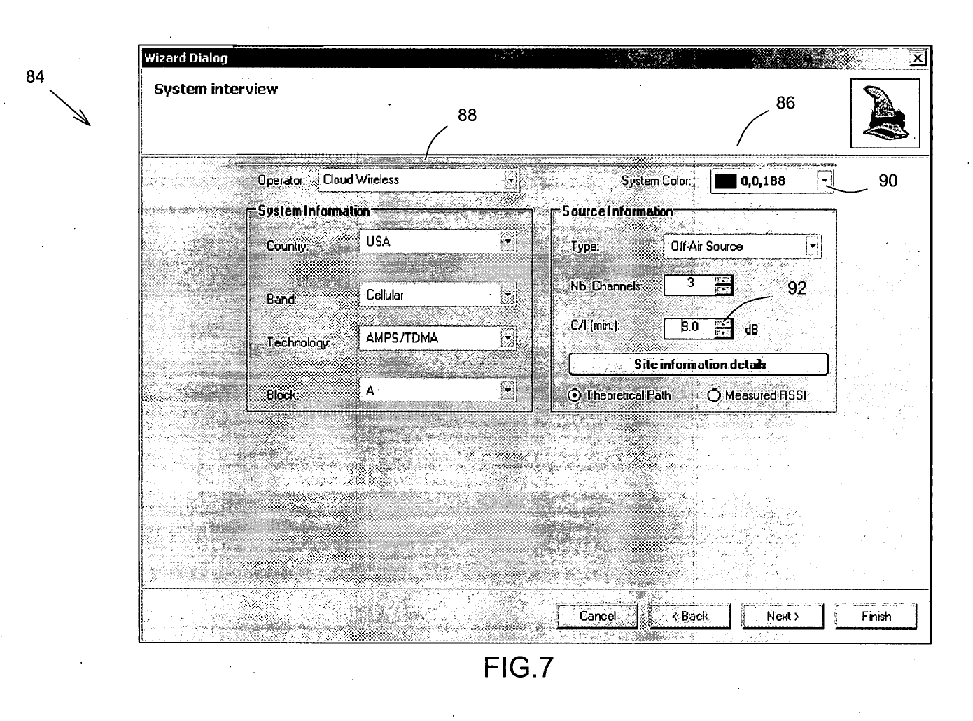

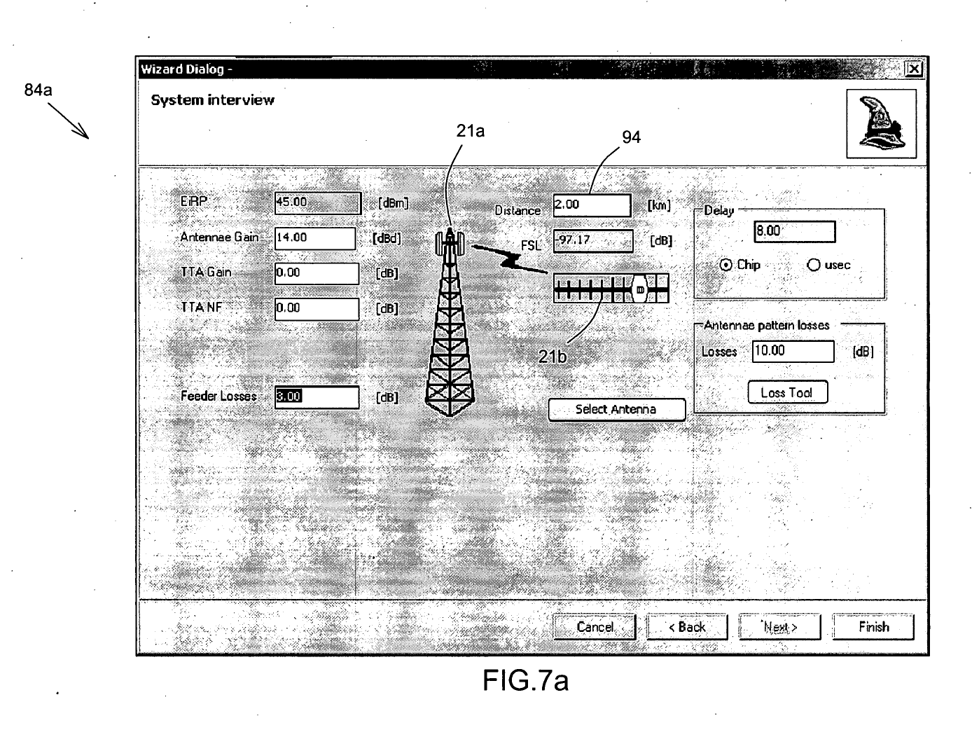

In a preferred aspect of the first embodiment, multiple signal source systems are interconnected with multiple components. The signal source system includes a signal source, a technology, a band of frequencies and a block of frequencies. The signal sources system types may include, for example, a Base Station source type, an Off-Air repeater source and the like, as illustrated in FIG. 7. The multiple signal source systems may include a variety of technologies, for example CDMA, AMPS, GPRS, UMTS, 802.11, etc., bands (e.g. Cellular, SMR, PCS, DCS, iDEN, ISM) and blocks of frequencies and the like. Additional step-automated in-building design software, which includes multiple systems support, may be added to the software of the present invention.

Preferably, the components database is accessible from the design screen canvas, the component being selected based on the specified system parameters.

Preferably, the component is selected from a list of available components based on specific properties of each of the available components. When two or more components are selected from the database, they are selected one after another.

In an important aspect of the first embodiment, the selected component is placed and represented on the design screen canvas.

In another important aspect of the first embodiment, the method further includes the steps of:
selecting a cabling component from the components database;
representing the selected cabling component on the design screen canvas; and
interconnecting the selected components using the selected cabling component.

Preferably, the selected components are interconnected on the screen design canvas using an on-screen pointing device implemented drag-and-drop technique. Those skilled in the art will understand that the on-screen pointing device may include keyboard or mouse implemented drag and drop, Tablet PCs, digitizing tablets, and the like.

In another important aspect of the first embodiment, the method further includes the steps of:
validating the compatibility of the interconnected components with the signal source system; and
calculating a link budget at each of the compatible interconnected components.

Further to the link budget calculations, numerous other design calculation tools such as Intermod Calculator, Frequency Calculator, Unit Converter, Cable Loss Calculator, Probe, Desktop Calculator and the like may also be used. One skilled in the art will recognize that the term link budget includes calculated downlink and uplink losses and/or gains at each of the connected system components. Downlink calculations may include calculations of power/channel, composite power, absolute gain/loss, CDMAPilot and Overhead power, and other technology specific parameters. Uplink calculations may include calculations of noise/channel, mobile power and carrier/noise and other technology specific parameters.

Further to the link budget calculations, additional data, such as cable loss, may be displayed or the software may be adapted to perform customized calculations.

Preferably, a debug window is displayed on the design screen canvas and displays debug window messages when the interconnected components are incompatible with a compatibility check preferably selected from the group consisting of: signal source systems, impedance verification, voltage compatibility, active component saturation, voltage drop, maximum power handling and connector type. More preferably, the compatibility check is signal source systems, active component saturation and connector types.

In another important aspect of the first embodiment, the method further includes the steps of:
transposing the interconnected components onto at least one installation plan of the wireless communications network.

Preferably, a first report is generated having thereon a graphical representation of the DAN.

Preferably, a second report is generated having thereon a graphical representation of the at least one installation plan.

Preferably, an equipment list is generated, the list including information on each of the components.

Preferably, a cost report is generated having thereon costing information based on cost data for each of the components.

Preferably, the interconnected components are transposed onto at least one floor plan of the building.

Although the wireless communications network is a wireless network and is preferably located within a building, one skilled in the art will recognize that the wireless communications network may also be located exterior of the building without deviating from the scope of the present invention.

Preferably, the interconnected components are transposed onto at least one floor plan of the building, as illustrated in FIG. 1a. The floor plans may include several levels, which may be represented on the design screen canvas as different floor levels within the building.

Preferably, the interconnected components are transposed onto an image or picture. The image or picture may include specific positioning information for use at the installation.

In an important aspect of the first embodiment, the design screen canvas is a graphical representation of the network. The design screen canvas is located on a computer display unit, which is typically a computer monitor screen.

The DAN is a 2-Dimensional representation of the wireless communications network, as illustrated in FIG. 1. The canvas can also represent elevation plan of the DAN. One skilled in the art will recognize that the DAN may also be represented in three dimensions.

According to a second embodiment of the present invention, there is provided a computer-implemented method for designing a wireless communications network, the method comprising the steps of:
creating a Distributed Antenna Network, as described above for the first embodiment; and
transposing the Distributed Antenna Network onto at least one installation plan of the wireless communications network.

Preferably, the installation plan includes a floor plan, a picture or an image.

II: Method Steps Stored on Computer-Readable Medium

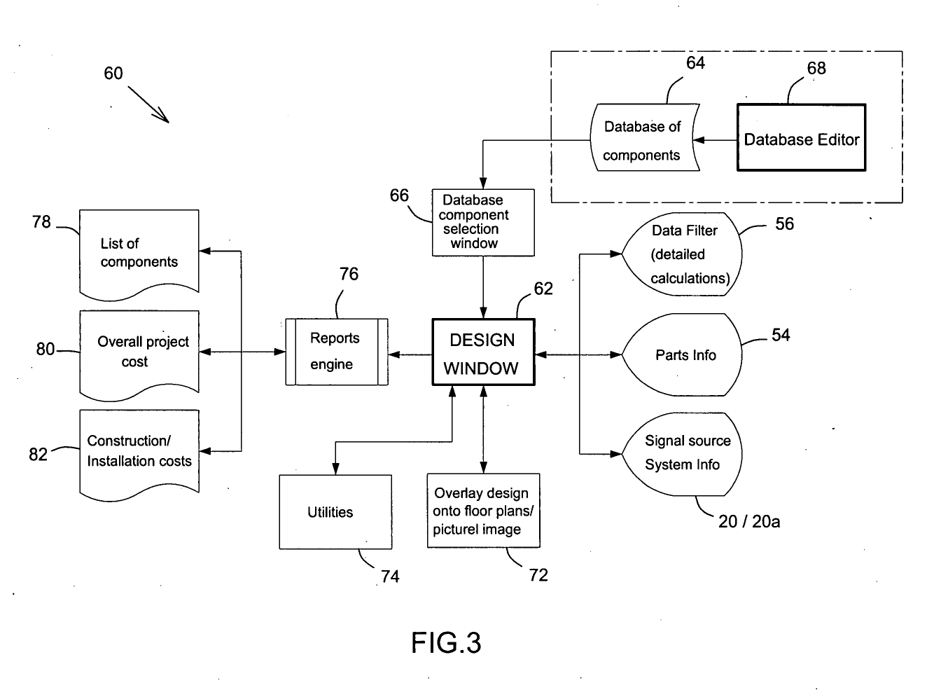

In a third embodiment of the present invention; there is provided a computer-readable data storage medium having a data storage material encoded with the computer implemented method steps of the first embodiment, as shown in a portion of FIG. 3.

In a fourth embodiment of the present invention, there is provided a computer-readable data storage medium having a data storage material encoded with the computer implemented method steps of the second embodiment, as shown in FIG. 3.

Examples of such computer readable media are well known to those skilled in the art and include, for example, diskettes (so called “floppy disks”), CD-ROM's and hard disks. Thus in accordance with the present invention, the method steps of the first and second embodiments can be stored in a computer-readable medium.

In a fifth embodiment of the present invention, there is provided a computer system for generating a 2-Dimensional representation of a Distributed Antenna Network, the system comprising:
a computer-readable storage medium including a data storage material encoded with the computer implemented method steps, as described above for the first embodiment;
a memory for storing instructions for processing the data;
a central processing unit coupled to the computer-readable storage medium for processing the computer readable data into the representation; and
a display unit coupled to the central processing unit for displaying the representation.

Preferably, the system also includes the pointing device operated screen cursor, which is connected to the computer system.

In a sixth embodiment of the present invention, there is provided a computer system for generating a representation of a wireless communications network, the method comprising:
a computer-readable storage medium including a data storage material encoded with the computer implemented method steps, as described in the second embodiment above;
a memory for storing instructions for processing the data;
a central processing unit coupled to the computer-readable storage medium for processing the computer readable data into the representation; and
a display unit coupled to the central processing unit for displaying the representation.

In a seventh embodiment of the present invention, there is provided a computer-readable medium having stored thereon a design of a Distributed Antenna Network, as described above for the first embodiment.

In an eighth embodiment of the present invention, there is provided a computer-readable medium having stored thereon a design of a wireless communication network, as described above for the second embodiment.

III: Wireless Communications Networks

In accordance with a ninth embodiment of the present invention, there is provided an in-building wireless communications network designed in accordance with the methods of the present invention.

Referring now to FIG. 1, the wireless communications network is shown generally at 10 and which is designed using an embodiment of a method of the present invention. Broadly speaking, the designed network 10 is illustrated as an elevated plan 12. The network 10 includes a number of representations of components 14 that are interconnected with a representation of a cabling component 16. The cabling component 16 may be radio frequency (RF), IF (intermediate frequency), twisted pair (CAT5) or optical cable. The wireless communication network 10 may typically be organized to display components on different floors using levels 12 of the building. At each of the system-components 14, link budget calculations 18 are shown in boxes. Two signal source systems 20, 20a each include a transmitter antenna 21a and a receiver antenna 21b. Two numbers 22a and 22b are illustrated with two different calculations (System 20: power/channel, and System 20a: noise/channel) that are defined in a calculation legend 24.

Referring now to FIG. 1a, a DAN is shown overlaid onto a floor plan of a building. Specifically represented in this illustration are indoor antennae 26, connected by indoor cabling components 28 and 36, a series of splitters 30, a donor antenna 32 and a donor antenna cable 34.

Although the wireless communications network 10 is represented within a building, it should be understood that the wireless communications network may be represented exterior of a building, without deviating from the scope of the present invention.

IV: Software Tool Suite

In accordance with a tenth embodiment of the present invention, there is provided a software tool suite for designing an in-building wireless communications network, the suite comprising:
a display, on a design screen canvas, of at least one defined signal source system having a source of signal and a plurality of specified system parameters;
a display of at least one selected component selected from a components database stored in a computer system and accessible from the design screen canvas, the component being selected based on the specified system parameters; and
a graphical representation of a DAN created by interconnecting the selected component on the design screen canvas.

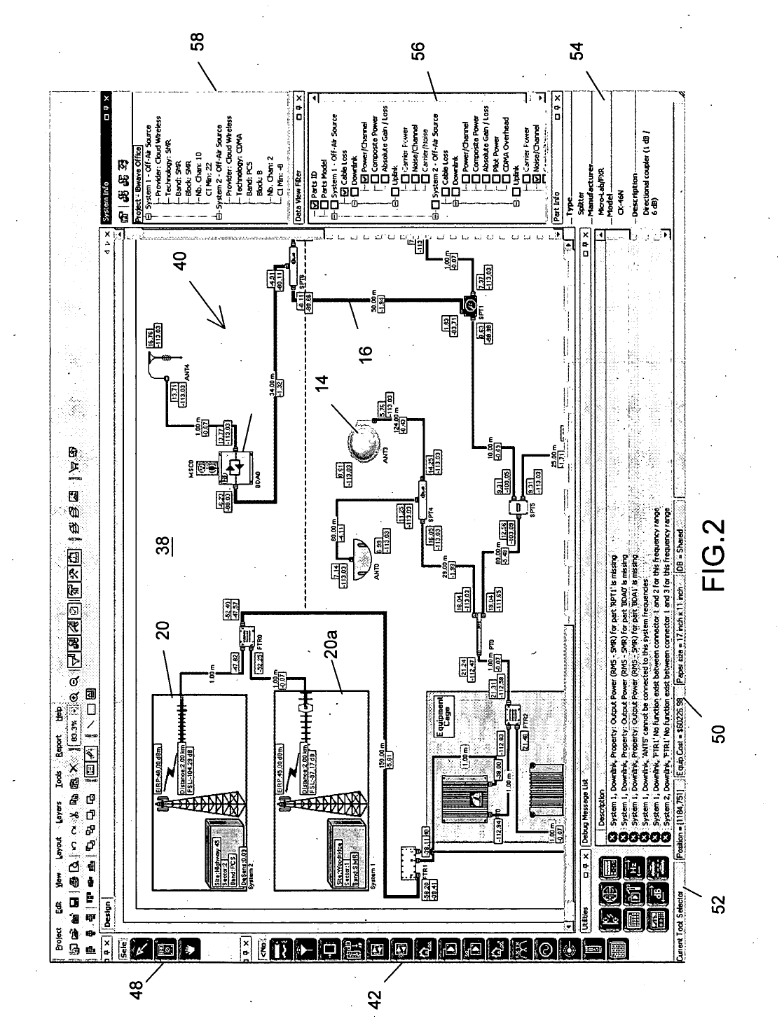

Referring now to FIG. 2, the two signal source systems 20, 20a are located on the design screen canvas 38. The DAN 40 is shown displayed on the canvas 38. The software suite includes toolbars on the left hand side of the screen and includes a component tool bar 42 and a selection toolbar 48. A debug window 50 is located at the bottom of the screen and includes a description of the aforesaid incompatibilities. At the bottom left hand side of the screen a utilities box 52 contains information used in the link budget calculations. At the bottom right hand side of the screen, current component information 54 is displayed. Link budget calculations options 56 are located in the middle of the right hand portion of the screen, whereas at the top of the right hand portion of the screen a signal source system list 58, which refers to the systems 20, 20a is displayed.

The software suite also has access to a database editor, a report generator, calculation utilities, which are typically not displayed on the primary screen of the software suite.

V: Methods and Systems for Generating Reports

In accordance with an eleventh embodiment of the present invention, there is provided a method of generating a report having thereon a graphical representation of a Distributed Antenna Network, the method comprising the steps of:
creating data from the DAN created as described in the first embodiment as described above;
storing instructions for processing the data;
processing the data in a central processing unit coupled to a computer-readable storage medium into the graphical representation and generating the graphical representation; and
displaying the graphical representation on a display unit coupled to the central processing unit.

In accordance with a twelfth embodiment of the present invention, there is provided a computer system for generating a report having thereon a graphical representation of a DAN, the system comprising:
a computer-readable storage medium including a data storage material encoded with the computer implemented method steps, as described in the first embodiment;
a memory for storing instructions for processing the data;
a central processing unit coupled to the computer-readable storage medium for processing the computer readable data into the graphical representation and for generating the graphical representation; and
a display unit coupled to the central processing unit for displaying the graphical representation.

In accordance with a thirteenth embodiment of the present invention, there is provided a method of generating a report having thereon a graphical representation of an installation plan, the method comprising:
creating data from the DAN created as described in the first embodiment as described above;
storing instructions for processing the data;
processing the data in a central processing unit coupled to a computer-readable storage medium into a graphical representation of the DAN and generating the graphical representation of the DAN;
displaying the graphical representation of the installation plan on a display unit coupled to the central processing unit.

In accordance with a fourteenth embodiment of the present invention, there is provided a computer system for generating a report having thereon a graphical representation of at least one installation plan, the system comprising:
a computer-readable storage medium including a data storage material encoded with the computer implemented method steps, as described in the first embodiment above;
a memory for storing instructions for processing the data;
a central processing unit coupled to the computer-readable storage medium for processing the computer readable data into the graphical representation and for generating the graphical representation; and
a display unit coupled to the central processing unit for displaying the graphical representation.

In accordance with a fifteenth embodiment of the present invention, there is provided a method of generating an equipment list for a wireless communications network, the method comprising the steps of:
creating data from the DAN created as described in the first embodiment as described above;
storing instructions for processing the data;
processing the data in a central processing unit coupled to a computer-readable storage medium into the equipment list and generating a graphical representation of the equipment list; and
displaying the graphical representation of the equipment list on a display unit coupled to the central processing unit.

In accordance with a sixteenth embodiment of the present invention, there is provided a computer system for generating an equipment list for a wireless communications network, the system comprising:
a computer-readable storage medium including a data storage material encoded with the computer implemented method steps, as described in the second embodiment;
a memory for storing instructions for processing the data;
a central processing unit coupled to the computer-readable storage medium for processing the computer readable data into the representation and for generating the equipment list; and
a display unit coupled to the central processing unit for displaying the equipment list.

In accordance with a seventeenth embodiment of the present invention, there is provided a method of generating a cost report for a wireless communications network, the method comprising the steps of:
creating data from the DAN created as described in the first embodiment as described above;
storing instructions for processing the data;
processing the data in a central processing unit coupled to a computer-readable storage medium into the cost report and generating a graphical representation of the cost report; and
displaying the graphical representation of the cost report on a display unit coupled to the central processing unit.

In accordance with an eighteenth embodiment of the present invention, there is provided a computer system for generating a cost report for a wireless communications network, the system comprising:
a computer-readable storage medium including a data storage material encoded with the computer implemented method steps, as described in the second embodiment as described above;
a memory for storing instructions for processing the data;
a central processing unit coupled to the computer-readable storage medium for processing the computer readable data into the representation and for generating the cost report containing cost information based on cost data associated with the system components; and
a display unit coupled to the central processing unit for displaying the cost report.
   Operation

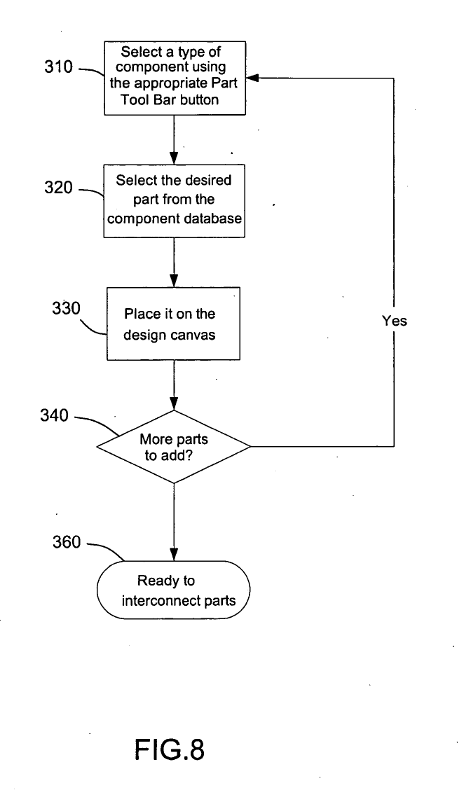

The operation of the software will now be described with reference to the flow diagrams in FIGS. 3, 4, 5, 6, 8, and 11.

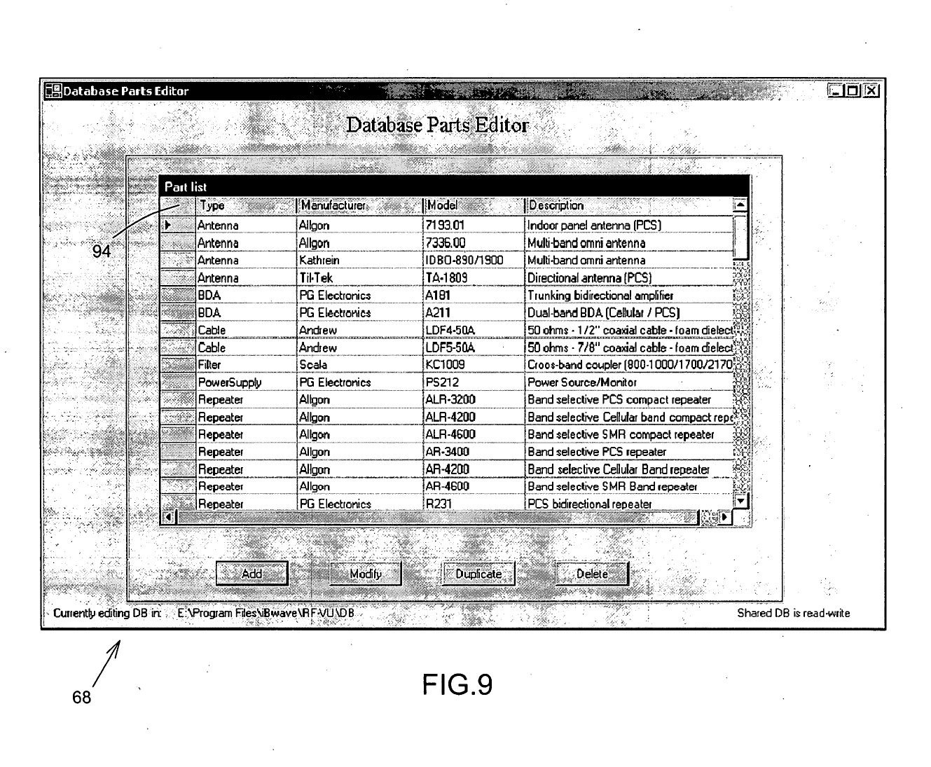

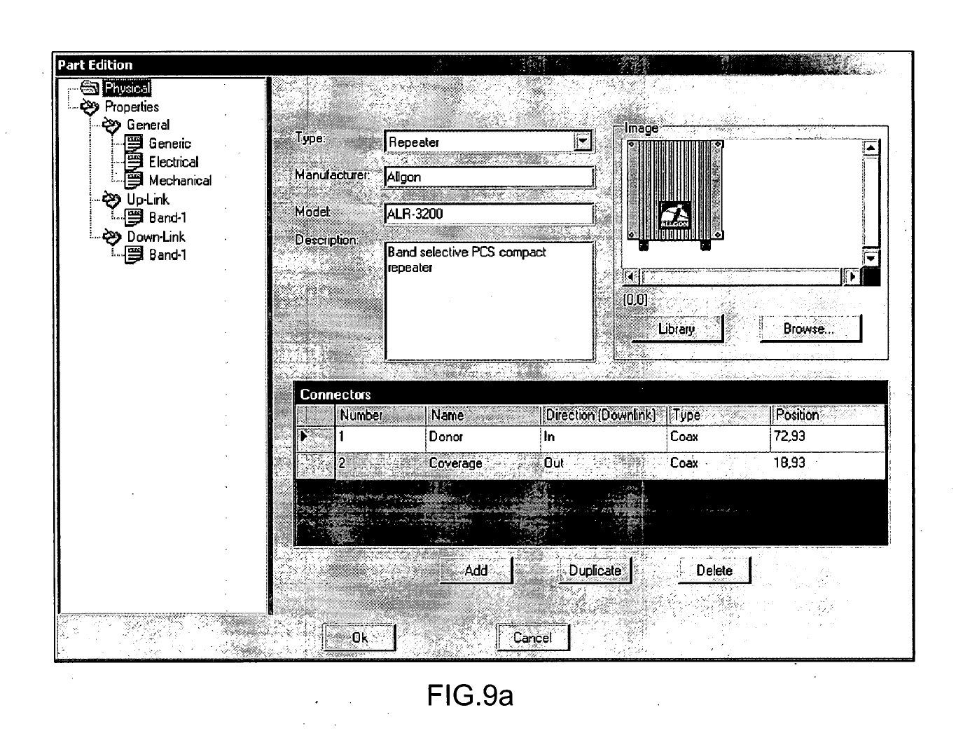

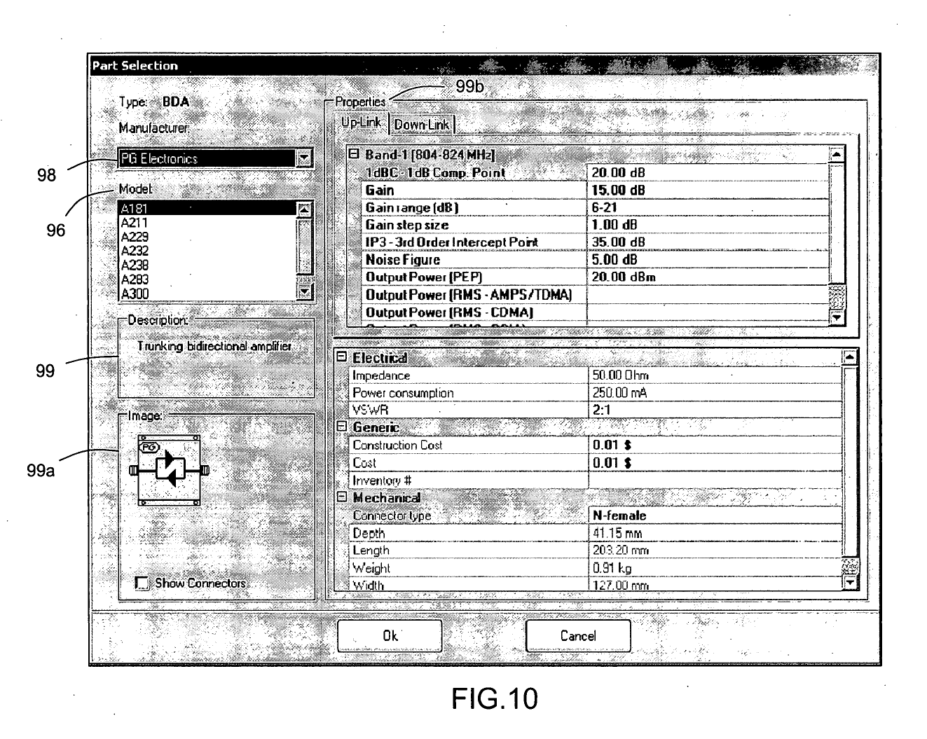

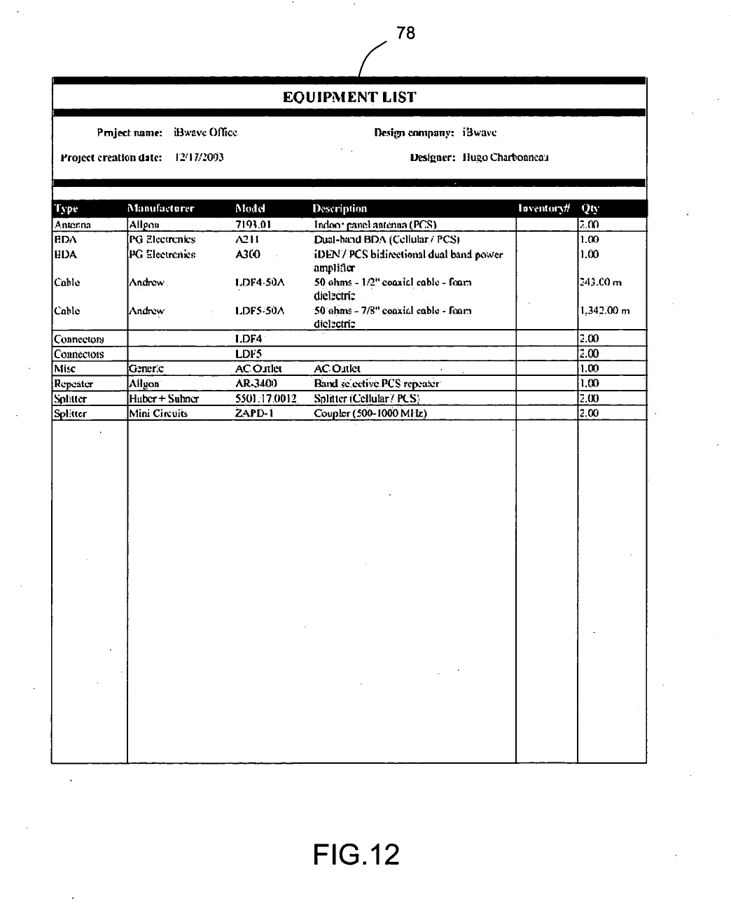

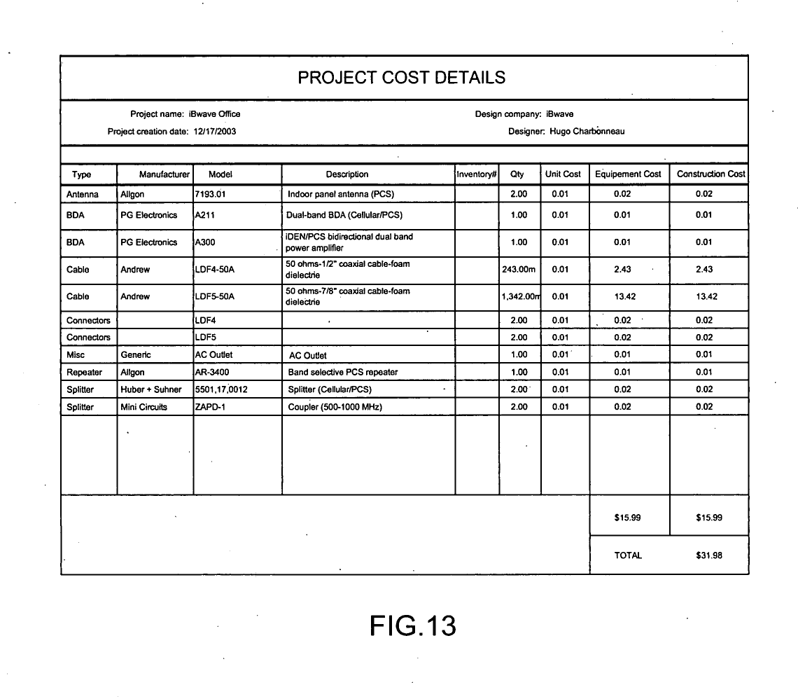

Referring specifically to FIG. 3, there is illustrated a block diagram of a system 60 of the present invention. As described above, the system 60 is typically part of a computer system and includes all of the steps described below in a single, fully integrated package. The system 60 is open architecture so as to expand to include future hardware and software developments. A design window 62 includes the design screen canvas 38 through which a database of components 64 may be accessed. A database selector 66, as illustrated also in FIG. 10, allows the designer to scroll through the database 64 to select a desired component. A database editor 68, as illustrated also in FIGS. 9 and 9a, is an independent software that can be used to modify/add/remove components from the database and includes parts information headings 94. Further, as a sub-part of the design window 62 is the data filter window 56, which performs detailed calculations such as the link budget. The parts information window 54 and the source signal system information window 20, 20a of the multiple systems are also sub-windows of the design window 62. Accessible on the design screen 62 are a utilities window 74 and the ability to generate reports 76 and a design for overlaying onto building floor plans/images or pictures 72. The reports 76 include a list of components (equipment list) 78, an overall cost of the project 80 and construction and/or installation costs (cost report) 82, all of which may be printed out, as seen in FIGS. 12 and 13.

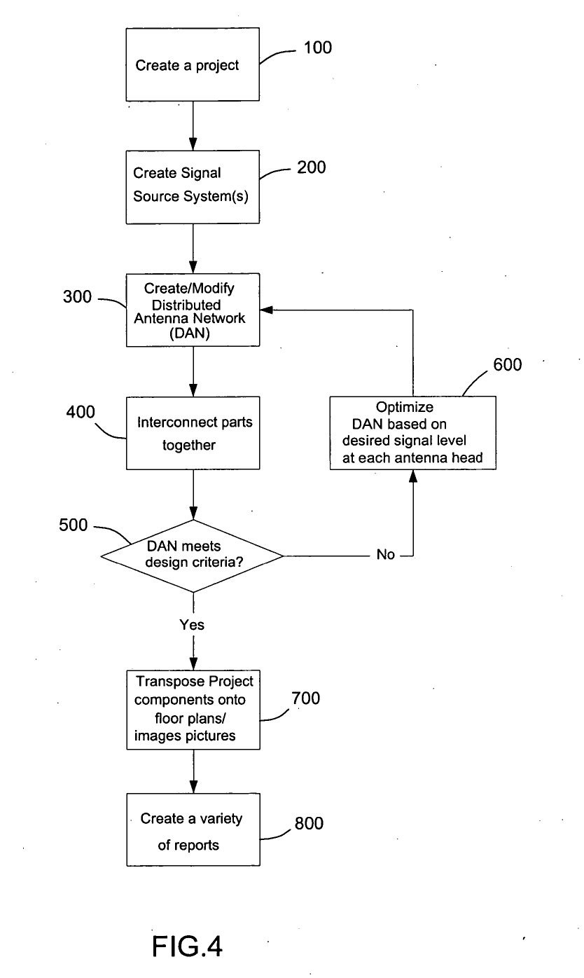

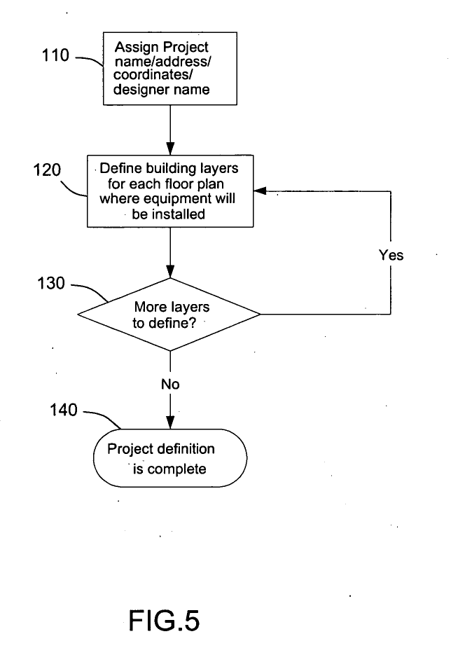

Referring specifically now to FIGS. 4 and 5, in which a flow diagram includes a series of blocks representing a general method of the present invention. Block 100 involves creating a project. On the computer screen, block 110 shows that a designer assigns project parameters such as a project name, company name, address, coordinates and designer name and the like. The designer then, at block 120 defines building layers for each floor plan where the network equipment will be installed by the site technician. Optionally, at block 130, the designer can add more layers and assign additional project parameters. If no other layers are to be added, then the project definition is deemed complete, as shown in block 140. The designer can, at anytime during the DAN design modify the project information and add/delete building layers.

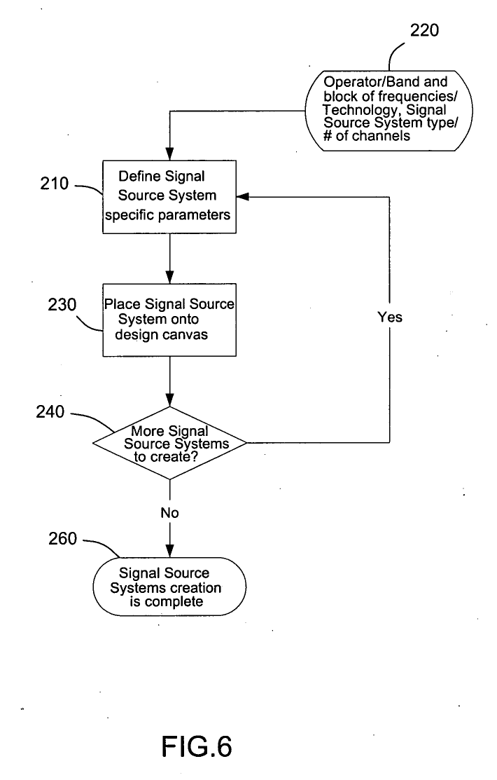

Referring now specifically to FIGS. 4 and 6, after the project has been created at block 100, the designer creates at least one signal source system at block 200. At blocks 210 and 220, the designer, for each of the systems, defines the signal source system specific parameters. After the system parameters have been defined, the designer places the system onto the design screen canvas at block 230. If additional systems are required, at block 240, the designer can repeat the aforesaid steps until the system creation, at block 260, is completed. A screen window 84, as illustrated in FIG. 7, enables the designer to visualize the system's creation and assign such visual properties as system color 86, operator name 88 and the like to the system, using selection from drop down 90 or scroll down menus 92. Other data entry windows 84a are used subsequently depending of the systems parameters, as seen in FIG. 7a, which illustrates, for example, the distance 94 between the antennae 21a and 21b.

Referring now specifically to FIGS. 4, 8, and 10, at block 300, the designer can now create and/or modify a DAN. At block 310, the designer selects a type of system component using an appropriate part tool bar button in a screen window. The window is linked to a components (or parts) database that is located on a computer hard drive or may be downloaded from a local or remote server, such as the Internet. A component is chosen, at block 320, from amongst a list of components using the specific properties of each available component. The screen window of the database includes selection criteria such as part model number 96, manufacturer 98 and brief description 99 and an icon of the component 99a with its properties 99b. The selected components added and then dragged and dropped onto the design screen canvas, using a cursor operated by a pointing device, at block 330. With each of the selected components, connectors are automatically generated by the component's defined location in the database. Every component connectors can be connected using the cabling component 16, which are typically graphical representations of cables. If required, more components can be added from the database and placed on the design screen canvas, at block 340 and the process repeated until the designer is ready to interconnect the system components at block 360 to produce a graphical representation of the DAN.

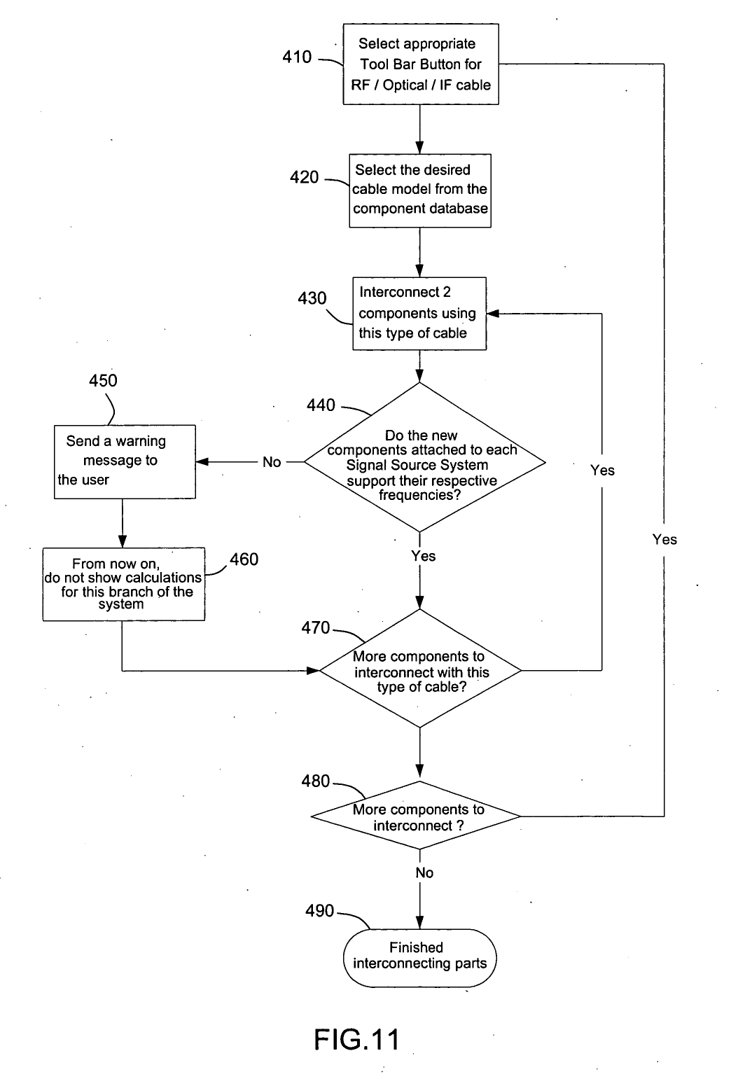

Referring now specifically to FIGS. 4 and 11, following creation and placing of the on screen components at block 300, the designer can now interconnect the system components at block 400.

At block 410, the designer selects the appropriate tool bar button for RF/Optical/IF/twisted pair cable and thereafter, at block 420, selects the desired cabling component model from the components database. The cabling component 16 is a line representing the cable on the canvas. The connector is the location on the component where the cabling component connects. The connectors are automatically generated for a component from the information in the database.

At this point at block 430, the designer interconnects, using the aforesaid selected cable model, at least two of the selected system components by dragging and dropping the representation of the components on the design screen canvas. At block 440, the designer performs a compatibility verification step to ensure that each of the connected components support the systems parameters connected as its signal source as described above. If the connected components are incompatible, at block 450, the warning message (In the debug window) 50, as shown in FIG. 2, alerts the designer to adjust the components or to replace them to reach a desired level of signal for each antenna and ensure component's compatibility with the systems. The warning message alerts the designer that the interconnected components require debugging and modification. Link budget calculations at each of the system components, at block 460, are not displayed until the compatibility is verified, otherwise the designer moves on to block 470.

If the system components are compatible using the type of cable model, the designer moves from block 440 to block 470 with the option to add additional components and to check and verify their compatibility at block 480. The calculation data displays link budget, from wireless device to signal source system, information to make sure sensitivity degradation of the system source is kept to a minimum and meets user-defined objective. Once the compatibility of the system components have been validated, the link budget calculations are performed at each of the connected components, as illustrated by the screen windows shown in FIGS. 1 and 2.

Referring now to FIG. 4, once the component parts are connected together, the designer makes the decision at block 500 whether the system meets the design criteria. If the system does not meet the criteria, the designer must, at block 600, optimize the systems based on the desired signal level of each antenna head by repeating the process starting at block 300 by modifying the components and/or interconnections. If the design is acceptable, at block 700 the DAN is ready to be overlaid or transposed onto a variety of installation plans.

Referring now to FIGS. 3, 4, 12 and 13, block 800 includes the step for generating design reports. The designer can now print the design laid onto the design canvas, print the floor plan layouts with components, obtain and print a list of components with associated costs if desired, obtain and print a construction/installation cost evaluation of its project. A site technician can also print installation plans for use in constructing the network. The topology of the system can be overlaid on building floor plans to ease the site technician's task with locating individual system components throughout the building. Components overlaid over picture or image can also be printed for the technician to specify the exact location of components with pictures. In FIG. 12, a screenshot of an equipment list includes information such as project name, designer name and project creation date across the upper part of the screen. Columns of equipment information include equipment type, manufacturer, model number, description and quantity. Additional columns may be added such as inventory number. Referring now to FIG. 13, a screenshot of a cost report, which includes tabulated information in columns of quantities, unit cost, equipment cost and construction cost information for all the components of the network. The cost report calculates the total cost of the equipment and the total cost of the construction of the network.

One skilled in the art will understand that all of the method steps described above may be interchanged without deviating from the scope of the present invention.

While specific embodiments has been described, those skilled in the art will recognize many alterations that could be made within the spirit of the invention, which is defined solely according to the following claims.

1. A computer-implemented method for creating a Distributed Antenna Network for use in designing a wireless communications network, the method comprising:
interconnecting on a design screen canvas at least one selected component, from a components database stored in a computer system, with at least one defined signal source system having a source of signal and a plurality of specified system parameters.

2. The method, according to claim 1, in which multiple signal source systems are interconnected with multiple components.

3. The method, according to claim 1, in which the components database is accessible from the design screen canvas, the component being selected based on the specified system parameters.

4. The method, according to claim 1, in which the component is selected from a list of available components based on specific properties of each of the available components.

5. The method, according to claim 1, in which the signal source system includes a signal source, a technology, a band of frequencies and a block of frequencies.

6. The method, according to claim 5, in which the selected component is placed and represented on the design screen canvas.

7. The method, according to claim 1, further includes:
selecting a cabling component from the components database;
representing the selected cabling component on the design screen canvas; and
interconnecting the selected components using the selected cabling component.

8. The method, according to claim 1, in which the selected components are interconnected on the screen design canvas using an on-screen pointing device implemented drag-and-drop technique.

9. The method, according to claim 1, further include:
validating the compatibility of the interconnected components with the signal source system; and
calculating a link budget at each of the compatible interconnected components.

10. The method, according to claim 9, in which a debug window is displayed on the design screen canvas, the debug window displaying debug window messages when the interconnected components are incompatible with a compatibility check selected from the group consisting of: signal source systems, impedance verification, voltage compatibility, active component saturation, voltage drop, maximum power handling and connector type.

11. The method, according to claim 10 in which the compatibility check is signal source systems, active component saturation and connector types.

12. The method, according to claim 1, further includes:
transposing the interconnected components onto at least one installation plan of the wireless communications network.

13. The method, according to claim 12, in which a first report is generated having thereon a graphical representation of the Distributed Antenna Network.

14. The method, according to claim 12, in which a second report is generated having thereon a graphical representation of the at least one installation plan.

15. The method, according to claim 12, in which an equipment list is generated, the list including information on each of the components.

16. The method, according to claim 12, in which a cost report is generated having thereon costing information based on cost data for each of the components.

17. The method, according to claim 1, in which the wireless communications network is located within a building.

18. The method, according to claim 17, in which the interconnected components are transposed onto at least one floor plan of the building.

19. The method, according to claim 1, in which the design screen canvas is a graphical representation of the wireless communications network.

20. The method, according to claim 1, in which the design screen canvas is located on a computer display unit.

21. The method, according to claim 1, in which the Distributed Antenna Network is a 2-Dimensional representation of the wireless communications network.

22. The method, according to claim 1, in which the wireless communication network is located exterior of the building.

23. A computer-implemented method for designing a wireless communications network, the method comprising:
creating a Distributed Antenna Network, according to claim 1; and
transposing the Distributed Antenna Network onto at least one installation plan of the wireless communications network.

24. The method, according to claim 23, in which the at least one installation plan includes a floor plan, a picture or an image.

25. A computer-readable data storage medium having a data storage material encoded with the computer implemented method steps, according to claim 1.

26. A computer-readable data storage medium having a data storage material encoded with the computer implemented method steps, according to claim 23.

27. A computer system for generating a 2-Dimensional representation of a Distributed Antenna Network, the system comprising:
a computer-readable storage medium including a data storage material encoded with the computer implemented method steps, according to claim 1;
a memory for storing instructions for processing the data;
a central processing unit coupled to the computer-readable storage medium for processing the computer readable data into the representation; and
a display unit coupled to the central processing unit for displaying the representation.

28. The system, according to claim 23, in which a pointing device operated screen cursor is connected to the computer system.

29. A computer system for generating a representation of a wireless communications network, the method comprising:
a computer-readable storage medium including a data storage material encoded with the computer implemented method steps, according to claim 23;
a memory for storing instructions for processing the data;
a central processing unit coupled to the computer-readable storage medium for processing the computer readable data into the representation; and
a display unit coupled to the central processing unit for displaying the representation.

30. A computer-readable medium having stored thereon a design of a Distributed Antenna Network, created according to claim 1.

31. A computer-readable medium having stored thereon a design of a wireless communication network, created according to claim 23.

32. An in-building wireless communications network designed, according to claim 23.

33. A software tool suite for designing an in-building wireless communications network, the suite comprising:
a display, on a design screen canvas, of at least one defined signal source system having a source of signal and a plurality of specified system parameters;
a display of at least one selected component selected from a components database stored in a computer system and accessible from the design screen canvas, the component being selected based on the specified system parameters; and
a graphical representation of a Distributed Antenna Network created by interconnecting the selected component on the design screen canvas.

34. Method of generating a report having thereon a graphical representation of a Distributed Antenna Network, the method comprising:
creating data from the Distributed Antenna Network created according to claim 1;
storing instructions for processing the data;
processing the data in a central processing unit coupled to a computer-readable storage medium into the graphical representation and generating the graphical representation; and
displaying the graphical representation on a display unit coupled to the central processing unit.

35. A computer system for generating a report having thereon a graphical representation of a Distributed Antenna Network, the system comprising:
a computer-readable storage medium including a data storage material encoded with the computer implemented method steps, according to claim 1;
a memory for storing instructions for processing the data;
a central processing unit coupled to the computer-readable storage medium for processing the computer readable data into the graphical representation and for generating the graphical representation; and
a display unit coupled to the central processing unit for displaying the graphical representation.

36. Method of generating a report having thereon a graphical representation of at least one installation plan, the method comprising:
creating data from the Distributed Antenna Network created according to claim 1;
storing instructions for processing the data;
processing the data in a central processing unit coupled to a computer-readable storage medium into a graphical representation of the Distributed Antenna Network and generating the graphical representation of the Distributed Antenna Network;
displaying the graphical representation of the at least one installation plan on a display unit coupled to the central processing unit.

37. A computer system for generating a report having thereon a graphical representation of at least one installation plan, the system comprising:
a computer-readable storage medium including a data storage material encoded with the computer implemented method steps, according to claim 1;
a memory for storing instructions for processing the data;
a central processing unit coupled to the computer-readable storage medium for processing the computer readable data into the graphical representation and for generating the graphical representation; and
a display unit coupled to the central processing unit for displaying the graphical representation.

38. Method of generating an equipment list for a wireless communications network, the method comprising:
creating data from the Distributed Antenna Network created according to claim 1;
storing instructions for processing the data;
processing the data in a central processing unit coupled to a computer-readable storage medium into the equipment list and generating a graphical representation of the equipment list; and
displaying the graphical representation of the equipment list on a display unit coupled to the central processing unit.

39. A computer system for generating an equipment list for a wireless communications network, the system comprising:
a computer-readable storage medium including a data storage material encoded with the computer implemented method steps, according to claim 23;
a memory for storing instructions for processing the data;
a central processing unit coupled to the computer-readable storage medium for processing the computer readable data into the representation and for generating the equipment list; and
a display unit coupled to the central processing unit for displaying the equipment list.

40. Method of generating a cost report for a wireless communications network, the method comprising:
creating data from the Distributed Antenna Network created according to claim 1;
storing instructions for processing the data;
processing the data in a central processing unit coupled to a computer-readable storage medium into the cost report and generating a graphical representation of the cost report; and
displaying the graphical representation of the cost report on a display unit coupled to the central processing unit.

41. A computer system for generating a cost report for a wireless communications network, the system comprising:
a computer-readable storage medium including a data storage material encoded with the computer implemented method steps, according to claim 23;
a memory for storing instructions for processing the data;
a central processing unit coupled to the computer-readable storage medium for processing the computer readable data into the representation and for generating the cost report containing cost information based on cost data associated with the system components; and
a display unit coupled to the central processing unit for displaying the cost report.
